(19) United States
(12) Patent Application Publication
(10) Pub. No.: US 2008/0209055 A1
(43) Pub. Date: Aug. 28, 2008

(54) DATA COMMUNICATION SYSTEM

(75) Inventors: Yuji Kazama, Mishima-shi (JP); Mitsuhiro Kinoshita, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/677,764

(22) Filed: Feb. 22, 2007

(51) Int. Cl. G06F 15/16

(52) U.S. Cl. 709/229

(57) ABSTRACT

A data communication system includes an address book provided with an address table having registered therein transmitter information of information via a facsimile and a mail and a user ID correlated with the transmitter information, and an ID information read unit configured to authenticate the user ID, and it conducts a search as to whether a registration has been made in the address book according to the authentication processing of the user ID and the transmitter information of the receipt information, and notifies the reception and permits an output the image data by a registrant having the user ID to whom confidentiality is specified when there is the transmitter information corresponding to the registration with confidentiality.

### BACKGROUND OF THE INVENTION

1. Field of the Invention

The present invention relates to a data communication system performing a transmission and a reception of information and furnished with a security capability for information that requires confidentiality.

2. Description of the Related Art

There has been a data communication system furnished with a capability with which data received from the outside and requiring the confidentiality of information is not outputted immediately but stored temporarily, so that the data is outputted after authentication of a particular pre-appointed user, such as a manager, is performed. As a system using the user authentication, a data communication system that can be shared among plural users while keeping the confidentiality is proposed, for example, in Japanese Patent Disclosure (Kokai) No. 2004-118464. This data communication system solves a problem that the memory region of a mail box where E-mails arrive is occupied temporarily by a particular high frequent user and becomes unavailable for a less frequent user. It is a data communication system configured in such a manner that plural user regions having a pre-determined memory capacity are provided in the internal memory and a password is set for each user region at the beginning, and an occupied state of the memory region is eliminated by imposing a limitation such that allows each user to use the system within his user region.

There is another data communication system having a capability of transferring reception data to a client PC of a particular user. An information data communication system and a communication method thereof for enabling a user to readily acquire his private information registered in the administrative institution using the ID card distributed to the user by transferring the private information to an outside, such as his home, while maintaining high security are proposed, for example, in Japanese Patent Disclosure (Kokai) No. 2004-23561.

In a case where this data communication system is a facsimile data communication system installed in a company, when the output authority of reception data is given to only a particular user, such as the manager, it becomes impossible to print-output reception data when this particular user is absent, which makes the system inconvenient. In addition, this particular user is involved in any output. This poses a risk that even when highly confidential reception data addressed to another user arrives, the content of the data may be known to this particular user during the print-output.

### BRIEF SUMMARY OF THE INVENTION

A data communication system includes: a communication unit configured to make a communication of information via a facsimile and a mail; a user card in which a user ID pre-assigned to a registrant is stored; a user memory unit configured to store an address book formed of an address table having registered transmitter information and the user ID correlated with the transmitter information in a rewritable manner; an ID information read unit configured to acquire the user ID from the user card; a RAM that stores the transmitter information of reception information; an image data accumulation unit configured to save image data of the reception information in correlation with the transmitter information; and a control unit (CPU) configured to conduct a search as to whether a registration has been made in the address book according to authentication processing of the user ID and the transmitter information of the reception information and to instruct the reception and permit an output of the image data by the registrant having the user ID to whom confidentiality is specified when there is the matching transmitter information.

Also, the data communication system provides an output method including: registering in advance transmission end information provided to communication information via a facsimile and a mail and a user ID correlated with the transmission information, and permitting an output of reception data by a registrant authenticated by the user ID when transmission end information of the reception data that has arrived matches the registered transmission end information.

### BRIEF DESCRIPTION OF THE SEVERAL VIEWS OF THE DRAWING

FIG. 1 is a block diagram showing an example of the configuration of one embodiment of a data communication system;

FIGS. 2A and 2B are views showing examples of registered data in an address book stored in a user memory unit according to the embodiment;

FIG. 3 is a flowchart used to describe registration procedure to the address book through key inputs;

FIG. 4 is a flowchart used to describe registration procedure to the address book using a call history according to the embodiment; and

FIG. 5 is a flowchart used to describe information reception processing in the data communication system according to the embodiment.

### DETAILED DESCRIPTION OF THE INVENTION

Hereinafter, one embodiment of the invention will be described in detail with reference to the drawings.

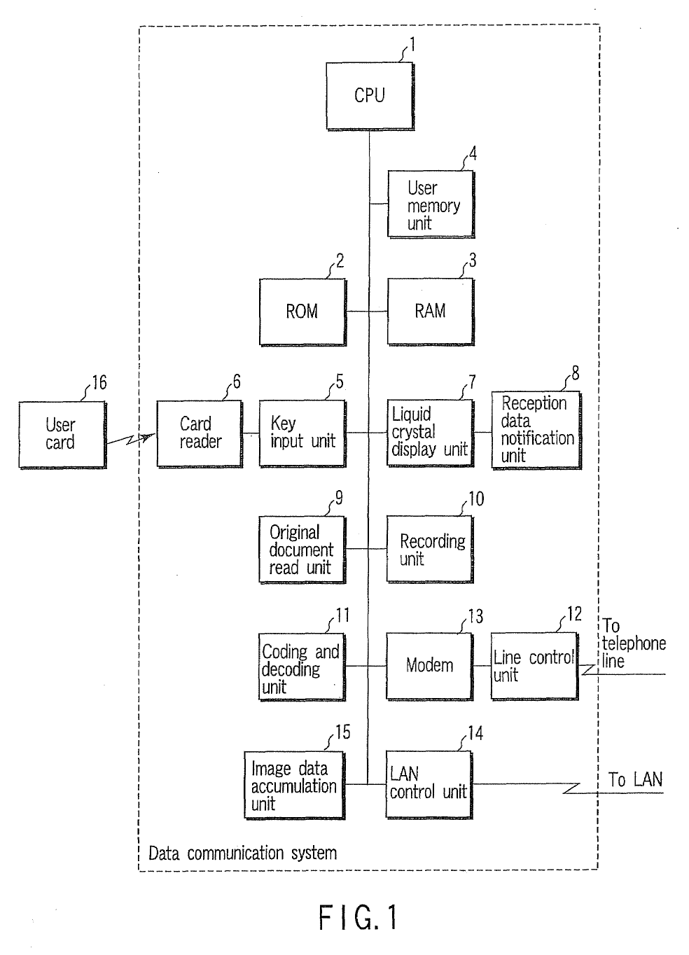

FIG. 1 is a block diagram showing an example of the configuration of one embodiment of a data communication system.

The data communication system includes a control unit (CPU: Central Processing Unit) 1 that controls the overall system, a ROM (Read Only Memory) 2 that stores program data or the like needed for the CPU 1 to control respective units, a RAM (Random Access Memory) 3 that stores control information of the respective units during operations, a user memory unit 4 formed of a rewritable non-volatile memory that stores an address book correlated with registered user ID's (individual identification numbers of operators who read out information), a key input unit 5 provided with various buttons for operations of the system, such as registration in the address book, a card reader 6 used to identify whether an operator operating the system is an authorized user, a liquid crystal display unit 7 that performs a display according to operations through the use of the key input unit 5, and a reception data notification unit 8 that receives communication information (hereinafter, referred to as the reception data) from the outside via a facsimile or a mail, and notifies “you receive new reception data” when the reception data is saved in an image data accumulation unit.

Further, it includes an original document read unit 9 that reads out a transmission original document or a copy original document, a recording unit 10 that print-records reception data on a recording sheet of paper, a coding and decoding unit 11 that converts image data into encoded data and decodes reception encoded data to image data, a line control unit 12 that transmits a signal to a facsimile machine at the other end and receives a signal from the facsimile machine at the other end by controlling a telephone line, a modem 13 that modulates encoded data from the coding and decoding unit 11 to be outputted to the line control unit 12 and demodulates a reception signal from the facsimile machine at the other end received at the line control unit 12, a LAN control unit 14 linked to the LAN to perform an E-mail transmission and an E-mail reception, and an image data accumulation unit 15 that accumulates image data or the like.

The CPU 1 controls the component units of the overall system and performs authentication processing of a user ID as described below and conducts a search as to whether a registration has been made in the address book according to transmitter information of information received from a party at the other end. Reception data of transmitter information that is not registered in the address book and reception data that does not require confidentiality are directly print-outputted. Meanwhile, for the transmitter information that requires confidentiality, an output of image data is permitted to a registrant having the user ID to whom confidentially is specified. In addition, it instructs to make a notification of a reception of reception data that requires confidentiality. In a case where reception data whose transmitter information has not been registered and that does not require confidentiality is received, a notification is not necessarily made or a notification may be made differently from the one made at the reception of reception data requiring confidentiality.

Each user owns a user card 16 in which is registered ID information to be read by the card reader 6 for user authentication. A non-volatile memory capable of storing and erasing information is suitable for the user memory unit 4, and for example, a flash memory is used. Regarding the data rewriting processing, rewriting can be performed for the flash memory each time the registration processing or the registered content correction processing is performed. Alternatively, data may be written again into the flash memory at a time when the rewriting processing is performed after data is read out temporarily in the RAM 3. In the user card 16, too, a flash memory or an IC chip furnished with the memory capability is incorporated so as to store ID information or the like. It is possible to use a ROM or the like for ID information that does not have to be updated or rewritten or in a case where the ID information is disposable and never written again. As will be described below, the user card 16 has an output terminal or is furnished with a communication capability.

In this embodiment, the coding and decoding unit 11, the line control unit 12, the modem 13, and the AN control unit 14 together form a communication unit (communication capability) to enable a transmission and a reception via a facsimile and an E-mail.

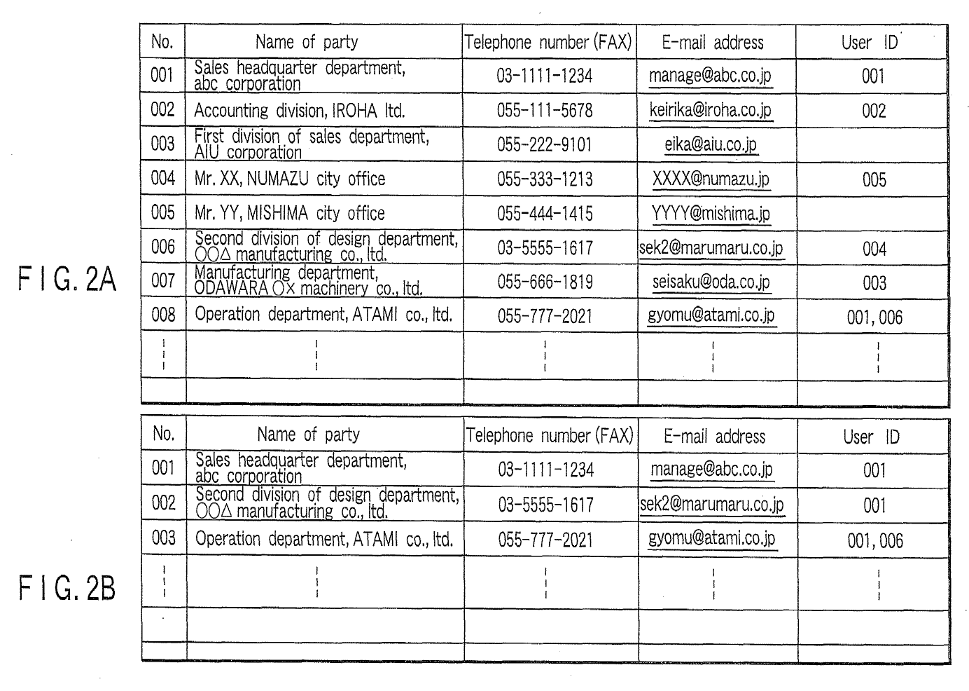

FIGS. 2A and 2B show examples of registered data in the address book stored in the user memory unit 4 in this embodiment.

FIG. 2A shows a master address book, in which confidential addresses that require confidentiality and non-confidential addresses that do not require confidentiality are registered by registering the user ID's. FIG. 2B is an individual address book selectively displayed from the master address book, and shows addresses to which confidentiality is set for each registrant, for example, the one having the user ID “ID001”. In these address books, an address table is set, in which at least the registration number, the name of party, the telephone number (facsimile number), the E-mail address, and the user ID are written. In the description below, these registration number, the name of a party, the telephone number (facsimile number), and the E-mail address are deemed as transmission end information. The address registration can be performed either from the master address book or the individual address book. In these address books, for example, as is indicated at the registration number 008, it may be configured in such a manner that more than one user ID is registered for a single client (customer). In other words, in a case where plural users, for example, a project team made up of plural members, are involved in one job with a given customer, the confidentiality is not necessarily limited to one user in terms of convenience.

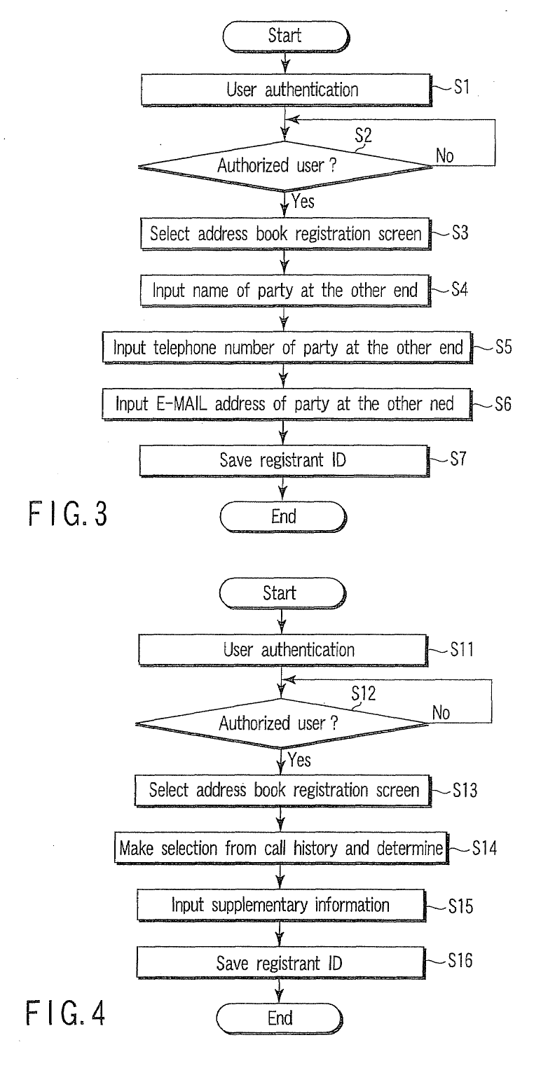

The registration procedure in the address book through key inputs in this embodiment will now be described with reference to the flowchart shown in FIG. 3.

In this embodiment, as an example of the user card 16, an employee ID card in the form of an IC card in which is recorded ID information made up of an employee number of an arbitrary set number is used. The ID information is not limited to a number made up of numerical values, and it may be character information, such as alphabets.

By furnishing, for example, a radio communication capability as a method for reading out the ID information from the user card 16 by the card reader 6, it is possible to read out the ID information by merely placing the user card 16 over the card reader 6. Besides this method, there may be a system, in which the ID information made up of numerical values or the like is written into the user card 16 in the form of a bar code, so that it is optically read out as the bar code information by the card reader 6 formed of a bar code reader. Further, there may be a system, in which a flash memory, an IC chip, or a magnetic tape is provided inside the user card 16, so that the ID information stored therein is read out by inserting or swiping the user card 16 in or through the slot of the card reader 6 to bring it into contact with the input terminal or the magnetic head.

The user initially displays the menu screen on the liquid crystal display unit 7 of the data communication system, and performs user authentication by allowing the card reader to read out the ID information in the user card 16 he owns (Step S1). For example, the user places the user card 16 used to identify the user, such an employee ID card, over the card reader 6 for the user ID to be read. In this user authentication, whether the user is an authorized user eligible to go through registration procedure is determined (Step S2). When the user is determined as being an authorized user in this determination (YES), the system shifts to a state where an input to the table is allowed. Meanwhile, when the user is determined as being an unauthorized user (NO), an input through the key input unit 5 is no longer accepted, and the registration procedure thereafter is rejected.

Subsequently, the user selects an address book registration screen using the key input unit 5 (Step S3). When this selection is made, the necessary items in the procedure are displayed on the liquid crystal display unit 7. FIG. 2A or FIG. 2B described above may be displayed in this instance. As the necessary registration items, the name of a party at the other end, the telephone (facsimile) number of a party at the other end, and the E-mail address of a party at the other end as described above are inputted step by step (Steps S4, S5, and S6). After these inputs are completed, for the transmitter information (address) that requires confidentiality, the ID information of the authorized user is automatically saved as the user ID. Meanwhile, for the transmitter information (address) that does not require confidentiality, the processing ends without any input (Step S7). In other words, the ID information of the user who registered the information of each party at the other end in the address book is saved in correlation with the information of the party at the other end thus inputted. It should be noted, however, that in a case where more than one user ID is registered in one user ID table as described above, the ID information may be saved through key inputs.

For a party with whom communications are made only via a facsimile transmission, the E-mail address of the party at the other end is not necessarily saved. Likewise, for a party with whom communications are made only via an E-mail, the facsimile number is not necessarily saved. Further, the authentication of the user ID performed before registration is not an essential condition. In a case where the user authentication is not performed before registration, it may be configured in such a manner that the user is able to view the table and register an address of a party at the other end that does not require confidentiality therein, but for registration that requires confidentiality, the user is not allowed to store such registration in the table unless the authentication processing by the user card 16 is completed in the last instance.

The registration procedure in the address book using a incoming call history of this embodiment will now be described with reference to the flowchart of FIG. 4.

The user initially performs user authentication by allowing the card reader to read out the ID information in the user card 16 he owns (Step S11). In this user authentication, whether the user is an authorized user eligible to go through registration procedure is determined (Step S12). When the user is determined as being an authorized user in this determination (YES), the system shifts to a state where an input to the table is allowed. Meanwhile, when the user is determined as being an unauthorized user (NO), an input through the key input unit 4 is no longer accepted, and the registration procedure thereafter is rejected.

Subsequently, the user selects an address book registration screen using the key input unit 4 (Step S13). When this selection is made, the necessary items in the procedure are displayed on the liquid crystal display unit 6. FIG. 2A or FIG. 2B described above may be displayed in this instance. Herein, the incoming call history is displayed to select and determine a desired party at the other end (Step S14). According to this determination, the name of a party at the other end, the telephone (facsimile) number of a party at the other end, and the E-mail address of a party at the other end are registered step by step. However, in a case where the incoming call history does not have all these registration items, the user inputs supplementary information via the key input unit 4 as needed (Step S15). After these inputs are completed, the ID information of the authorized user is automatically saved as the user ID (Step S16). In other words, the ID information of the user who registered the information of each party at the other end in the address book is saved in correlation with the information of the party at the other end thus inputted. The ID information of the user may be inputted through key inputs.

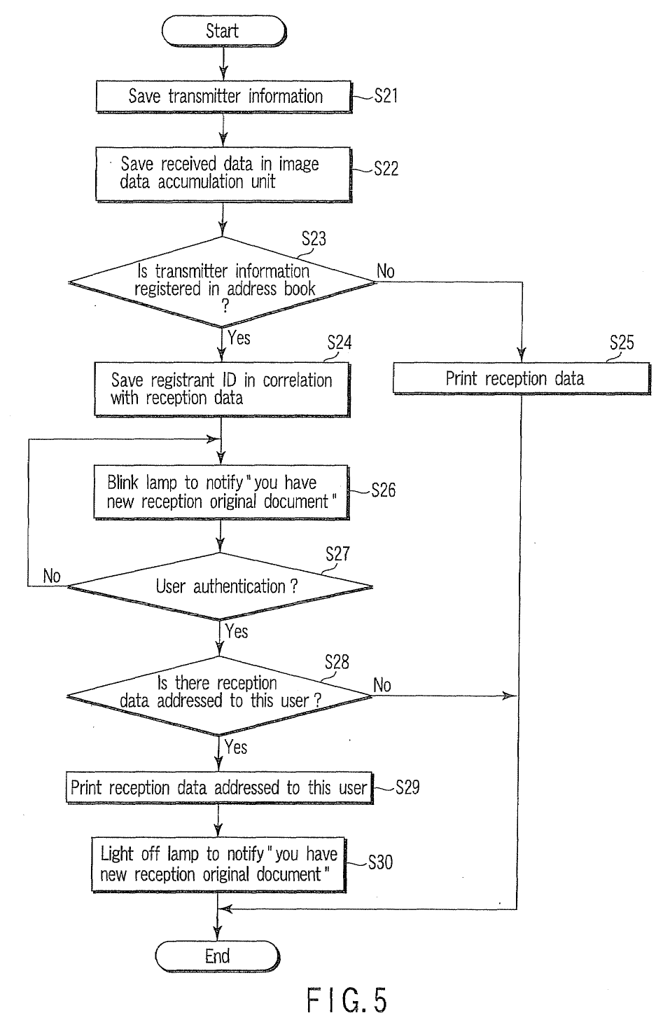

Information reception processing in the data communication system of this embodiment will now be described with reference to the flowchart shown in FIG. 5.

Herein, a case where a facsimile transmission that requires confidentiality is received at the data communication system will be described. Initially, when information (image data) arrives from the outside via the telephone line, the transmitter information (the name of the transmitter, the facsimile number of the transmission end, and so forth) is detected from the reception signal (for example, header information), which is temporarily saved in the RAM 3 (Step S21). Subsequently, the received image data is stored successively in the image data accumulation unit 15 in correlation with the transmitter information, and the communication ends (Step S22).

Thereafter, a search (reference) is conducted as to whether the user ID is registered in the address book with the transmitter information temporarily stored in the ROM 3 (Step S23). In a case where it turned out from the result of the search that the transmitter information is not registered in the address book or it is in the address book but the user ID is not registered (NO), the transmitter is determined as being an unspecified party or the reception data is determined as having no confidentiality, and the reception data is print-outputted (Step S25). Meanwhile, in a case where the transmitter information is in the address book and the user ID is registered (YES), the reception data is determined as requiring confidentiality, and the user ID is saved in correlation with the transmitter information (Step S24). Thereafter, the reception data notification unit 8 blinks (or lights ON) the lamp equipped thereto to notify “you have new reception data (reception original document)” (Step S26). Along with this blinking, the name of the transmitter and the name of the registrant having the user ID as the recipient may be displayed on the liquid crystal display unit 7. Further, in a case where the data communication system establishes a network connection with more than one terminal the registrants use via the LAN line or the like, even when the terminal of the corresponding registrant is in the middle of another processing, “you have new reception data (reception original document)” may be displayed on the display unit as a pop-up message.

When notified of the reception data, the user goes to the data communication system and goes through the user authentication processing to enable him to make operations involved with the confidential information (Step S27). To be more specific, he places the user card 16 (ID card) he owns over the card reader 6 for the user ID to be read. The authentication processing is then performed on the user ID thus read out, and whether the user is allowed to make operations involved with the confidential information is determined (Step S28). In a case where the user is found not to be an authorized user eligible to receive the reception data in this determination (NO), the system shifts to a state where an operation thereafter is no longer accepted. The system then returns to Step S26 and stays in a state notifying “you have new reception data”. Meanwhile, in a case where the user is found to be an authorized registered user in this determination (YES), the key input unit 4 and the liquid crystal display unit 6 shift to an operable state.

The user then conducts a search through the incoming call history to check whether any new reception data addressed to him has arrived through operations on the key input unit 5. When there is no new reception data addressed to him (NO), he ends the processing to return the system to the normal facsimile reception state. Meanwhile, when there is new reception data addressed to him, he print-outputs the reception data (Step S29). After the print-output of this reception data completes, the lamp indicating “you have new reception data” is lit OFF and the system returns to the normal facsimile reception state (Step S30).

This embodiment described a case where reception data is automatically print-outputted upon user authorization when reception data addressed to this user is saved. However, in a case where there is more than one piece of reception data, it may be configured in such a manner that reception data is print-outputted after the user selects the reception data he wishes be print-outputted using the key input unit 4. The embodiment described the case of a facsimile reception. However, the invention is not limited to a facsimile reception, and the same capability may be furnished in the case of an internet facsimile reception via the LAN line.

As has been described, the data communication system of this embodiment is not able to print-output reception data unless the user is authorized as the user who registered the transmitter information in the address book with his user ID. Hence, there will be no risk that the reception data is seen or taken away by a third party, which makes it possible to achieve confidentiality for reception data.

What is claimed is:

1. A data communication system, comprising:
a communication unit configured to perform a transmission and a reception of communication information via a facsimile and a mail;
a user memory unit configured to have an address table in which transmission end information and a user ID correlated with the transmission information have been previously registered; and
a control unit configured to conduct a search as to whether transmission end information in the received communication information matches the transmission end information registered in the address table and to permit an output of the communication information by a registrant authorized by the user ID when there is the matching transmission end information.

2. A data communication system, comprising:
a communication unit configured to make a communication of information via a facsimile and a mail;
a user card in which a user ID pre-assigned to a registrant is stored;
a user memory unit configured to store an address book formed of an address table having registered transmitter information and the user ID correlated with the transmitter information in a rewritable manner;
an ID information read unit configured to acquire the user ID from the user card;
a RAM that stores the transmitter information of reception information;
an image data accumulation unit configured to save image data of the reception information in correlation with the transmitter information; and
a control unit configured to conduct a search as to whether a registration has been made in the address book according to authentication processing of the user ID and the transmitter information of the reception information and to permit an output of the image data by the registrant having the user ID to whom confidentiality is specified when there is the matching transmitter information.

3. The data communication system according to claim 1, wherein:
in the address table having registered the address book are stored addresses that require confidentiality and addresses that do not require confidentiality in a mixed manner; and
for the addresses that require confidentiality, a name of a party at the other end, a telephone number of the party at the other end, and an E-mail address of the party at the other end are included as the transmitter information, and at least one user ID correlated with the transmitter information is registered in the address table.

4. The data communication system according to claim 1, further comprising:
a reception data notification unit configured to have at least one of a lamp to notify a reception by emitting light and a liquid crystal display unit configured to display a name of the registrant having the user ID as a recipient of the reception data upon reception of the information.

5. The data communication system according to claim 4, wherein:
in a case where the system is connected to plural terminals used by registrants via a network line, the reception data notification unit displays an arrival in a pop-up manner on the liquid crystal display unit even in middle of another processing.

6. The data communication system according to claim 1, wherein:
the data communication system has a network configuration to be connected to plural terminals used by registrants having user ID's via a LAN line, and includes a reception data notification unit configured to notify a terminal of a corresponding registrant of a reception of the information upon reception of the information.

7. The data communication system according to claim 2, further comprising:
a key input unit configured to enable a selection of image data to be print-outputted in a case where plural pieces of the image data to which an output is permitted by the control unit have arrived.

8. The data communication system according to claim 7, wherein:
the key input unit does not accept an input in a case where a user is determined as an unauthorized user during authentication processing of the user ID, and rejects a procedure thereafter.

9. The data communication system according to claim 7, wherein:
in a case where user authentication is not performed before a registration, the key input unit allows a registration of an address of a party at the other end requiring no confidentiality and rejects an input for storing processing unless a user is determined as an authorized user in the authentication processing for a registration requiring confidentiality.

10. An output method in a data communication system, comprising:
registering in advance transmission end information provided to communication information via a facsimile and a mail and a user ID correlated with the transmission information; and
permitting an output of reception data by a registrant authenticated by the user ID when transmission end information of the reception data that has arrived matches the registered transmission end information.

11. The output method in a data communication system according to claim 10, wherein a registration method of the user ID correlated with the transmission information includes:
allowing a registration operation by authentication by a pre-assigned user ID;
inputting the transmission end information made up of at least a name of a party at the other end, a telephone number of the party at the other end, and an E-mail address of the party at the other end into an address table through the registration operation; and
registering the transmission end information by providing the user ID to the address table of the transmission information inputted.

12. The output method of a data communication system according to claim 10, further including:
temporarily storing transmitter information included in reception data that has arrived;
storing image data in the reception data in correlation with the transmitter information;
conducting a search as to whether the transmitter information matches with the transmitter information registered previously in correlation with the user ID;
outputting the image data when there is no matching transmitter information as a result of the search; and
notifying a reception when there is the matching transmitter information and permitting an output of the image data by the registrant having the user ID registered in correlation with the transmitter information.

13. The output method of a data communication system according to claim 10, wherein:
the user ID is stored in a memory of a portable user card furnished with a communication capability, and the user ID is transmitted by placing the user card over a card reader in the data communication system, so that authentication by the user ID is proved from matching with a pre-registered user ID.

14. The output method of a data communication system according to claim 6, wherein:
the user ID is stored in a memory of the user card and the user ID is read out through an electrical connection established when the user card comes into contact with an input terminal of a card reader of the data communication system, so that authentication by the user ID is proved from matching with a pre-registered user ID.

15. A data communication system, comprising:
communication means for performing a transmission and a reception of communication information via a facsimile and a mail;
user memory means for having an address table in which transmission end information and a user ID correlated with the transmission information have been previously registered; and
control means for conducting a search as to whether transmission end information in the received communication information matches the transmission end information registered in the address table, and permitting an output of the communication information by a registrant authenticated by the user ID when there is the matching transmission end information.

16. The data communication system according to claim 15, wherein:
in the address table are stored addresses that require confidentiality and addresses that do not require confidentiality in a mixed manner; and
for the addresses that require confidentiality, a name of a party at the other end, a telephone number of the party at the other end, and an E-mail address of the party at the other end are included as the transmitter information, and at least one user ID correlated with the transmitter information is registered in the address table.

17. The data communication system according to claim 15, further comprising:
reception data notification means for having at least one of light emission means for notifying a reception by emitting light and liquid crystal display means for displaying a name of the registrant having the user ID as a recipient of the reception data upon reception of the information.

18. The data communication system according to claim 11, wherein:
the data communication system is connected to plural terminals used by registrants having user ID's via a LAN line and includes network means for notifying a terminal of a corresponding registrant of a reception of the information upon reception of the information.

19. The data communication system according to claim 2, further comprising:
for the authentication processing of the user ID by the control unit,
a user card furnished with a radio communication function and an electronic information storage unit formed of any one of a flash memory, an IC chip, and a magnetic tape, for recording ID information therein; and
a card reader that reads out the ID information by the radio communication capability.

20. The data communication system according to claim 2, further comprising:
for the authentication processing of the user ID by the control unit,
a user cart that records the ID information as a car code; and
a bar code reader that optically reads out bar code information from the user card.
